(19) United States
(12) Patent Application Publication
(10) Pub. No.: US 2015/0150405 A1
(43) Pub. Date: Jun. 4, 2015

(54) SEDIMENT FILTER

(71) Applicant: Remington Designs, LLC, Valencia, CA (US)

(72) Inventor: Bruce D. Burrows, Valencia, CA (US)

(21) Appl. No.: 14/558,576

(22) Filed: Dec. 2, 2014

Related U.S. Application Data
(60) Provisional application No. 61/910,937, filed on Dec. 2, 2013.

(51) Int. Cl. A47J 31/06; A23L 2/72

(52) U.S. Cl. CPC A47J 31/0626; A23L 2/72; A23V 2002/00

(57) ABSTRACT

The sediment filter includes a generally three-sided pocket having one or more mesh screens forming the bottom and/or side surfaces for filtering sediment or other particulate in a brewed beverage being dispensed from a coffee brewer or the like. The filter selectively attaches to a portion of the carafe such as the lid or upper open rim and is positioned to filter brewed beverage flowing through an inlet port or passageway into the carafe reservoir. The mesh screens permit flow-through of the brewed beverage while simultaneously trapping or capturing suspended particles therein.

### BACKGROUND OF THE INVENTION

The present invention generally relates to a sediment filter. More specifically, the present invention relates to a sediment filter selectively engageable or positionable within a carafe or the like to filter sediment (e.g., coffee grounds) from a brewed beverage such as coffee or tea downstream from the brew basket.

There are a wide variety of products on the market for brewing coffee. In particular, the coffee brewers shown and described in U.S. Pat. Nos. 6,968,775; 7,240,611; and 7,340,991, the contents of each being herein incorporated by reference in their entireties, are suitable for use in residential or commercial environments to produce brewed coffee. Such coffee brewers commonly include a water reservoir from which a predetermined volume of water is heated and then injected into a brew basket by a set of jet ports. The hot water streams delivered into the brew basket turbulently agitate and stir the coffee grounds contained therein to produce a substantially fluidized bed of water-borne coffee grounds for improved flavor extraction. This fluidized bed is directed against one or more mesh filter elements forming a wall portion of the brew basket for outward passage of the thus-produced coffee, which is directed into an underlying carafe, decanter, or the like. At least some of the jet ports are positioned underneath the level of coffee grounds in the brew basket so the heated water jetted or sprayed into the brew basket immediately and thoroughly wets the coffee grounds with an agitating and stirring action effective to left, suspend, and turbulently stir the grounds in a manner that produces the substantially fluidized bed of water-borne grounds. The jet ports, for example, are typically oriented to rotationally stir the coffee grounds with a substantial spinning or orbital path of motion. As a result, the brew basket shown and described with respect to the above-identified U.S. patents does not require the use of a coffee filter to trap the coffee grounds and other undesirable contaminants from being dispensed into the underlying carafe or container for later consumption.

Instead, the spinning fluidized bed is directed in centrifugal action in a generally radially outward direction against an inboard side wall of the brew basket, a portion of which is defined by a mesh filter element or elements that permit outward flow-through passage of the brewed liquid coffee while substantially preventing outward passage of coffee grounds. The brewed coffee passed through the filter element or elements is directed further as by gravity flow into an underlying coffee pot, such as a carafe, decanter, or the like. Unfortunately, however, the mesh filter element or elements cannot be expected to filter all coffee grounds from the outflow of brewed coffee from the brew basket. As a result, small amounts of coffee grounds or sediment may travel through to the bottom of the carafe or decanter. While this coffee essence at the bottom of the carafe provides rich flavor to the brewed coffee, it may be undesirable for some coffee drinkers.

Accordingly, there is a need in the art for a filter selectively engageable with a carafe, decanter or the like known in the art, for filtering coffee grounds, sediment or other suspended particles contained in a stream of brewed beverage (e.g., coffee) dispensing from a brew basket or brewer head, and into the underlying carafe, decanter or the like. The present invention fulfills these needs and provides further related advantages.

### SUMMARY OF THE INVENTION

The sediment filter disclosed herein is configured to be disposed within a carafe, decanter or the like, and underneath a brewed beverage steam (e.g., a coffee) for filtering sediment or other suspended particulate out therefrom. The filter is preferably generally formed as an upwardly open pocket and includes an upper rim for sealing the filter to a carafe lid. In one embodiment, the filter may connect to the carafe lid by a pair of hooks that selectively slideably engage a respective pair of receptacles in the lid. The three-sided pocket includes a porous base surrounded by upwardly extending and porous sidewalls designed to trap and remove suspended sediment or particulate from the brewed beverage stream, while simultaneously passing filtered beverage to the carafe reservoir below. The porous base and porous sidewalls are preferably made from a mesh filter screen or comparable filtration surface that permits brewed beverage to easily flow therethrough, while small enough to trap and filter out sediment suspended in the brewed beverage. The sediment filter may receive brewed beverage containing the sediment or particulate matter via a beverage inlet port in the carafe lid located underneath a beverage source, such as a brewer head. The carafe stores the filtered brewed beverage in a reservoir for later serving while the sediment remains inside the filter for later disposal and cleaning.

The filter preferably also includes at least one overflow channel to prevent beverage overflow from the filter when opening the carafe lid, while pouring brewed beverage out from the reservoir, or during a brew cycle. More specifically, sediment accumulation on the inside of the porous base and porous sidewalls may cause small amounts of liquid to remain inside the filter after a brew cycle. When pouring filtered brewed beverage from the carafe reservoir, the carafe is tipped forward to a position that may cause residual liquid in the filter to flow forward to the top of the upper rim. In this respect, the overflow channels permit this small amount of liquid to dispense out into the reservoir instead out through the lid. Similarly, when removing the filter from the carafe, opening the lid can cause the filter attached thereto to tilt backwards and spill the residual liquid therein. But, the overflow channels drain this small amount of liquid into the reservoir without spillage. Additionally, the overflow channels can be used to empty brewed beverage into the reservoir during a brew cycle in the event the filtration rate becomes too slow.

Other features and advantages of the present invention will become apparent from the following more detailed description, when taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a perspective view of one embodiment of a sediment filter as disclosed herein in hooked engagement with a lid of a typical carafe known in the art;

FIG. 2 is an exploded side view of the sediment filter and carafe of FIG. 1, further illustrating the positioning of the sediment filter relative to the carafe reservoir and carafe lid;

FIG. 3 is a cross-sectional view taken generally about Line 3-3 in FIG. 1, further illustrating hooked engagement of the sediment filter with the carafe lid;

FIG. 4 is a perspective view of the sediment filter of FIG. 1, further illustrating a pair of hooks, each being positioned between a pair of overflow channels, the hooks being configured for selective engagement with the carafe lid as shown in FIGS. 1 and 3;

FIG. 5A is a side view of the sediment filter of FIG. 1, further illustrating filtering through a porous base with initial accumulation of sediment thereon;

FIG. 5B is a side view of the sediment filter of FIG. 5A, further illustrating filtering through a porous sidewall as a result of decreased filtration through the porous base resulting from increased sediment accumulation thereon;

FIG. 6 is a perspective view similar to FIG. 1, illustrating an alternative embodiment of a sediment filter snapped into an open upper rim of the carafe;

FIG. 7 is a perspective view of the alternative sediment filter of FIG. 6;

FIG. 8 is an enlarged perspective view similar to FIG. 6, further illustrating the alternative sediment filter of FIGS. 6-7 retaining a plurality of lemons; and

FIG. 9 is a perspective view similar to FIGS. 1 and 6, illustrating another alternative embodiment of the sediment filter attached to the carafe by a support post extending from the bottom of the carafe.

### DETAILED DESCRIPTION OF THE PREFERRED EMBODIMENTS

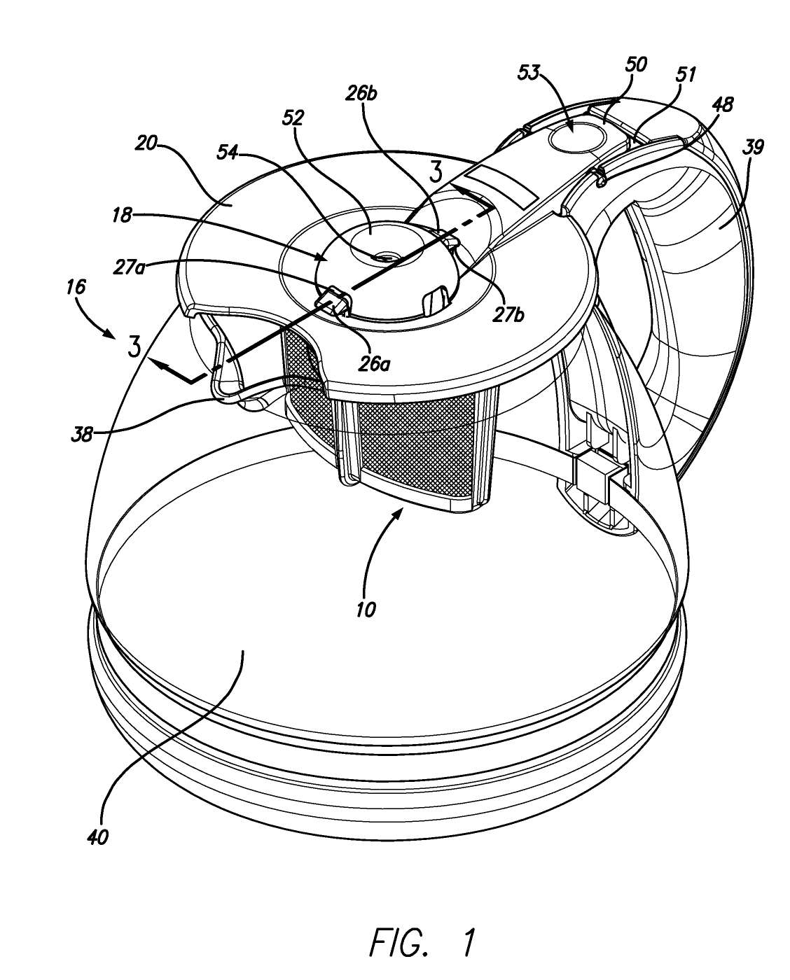

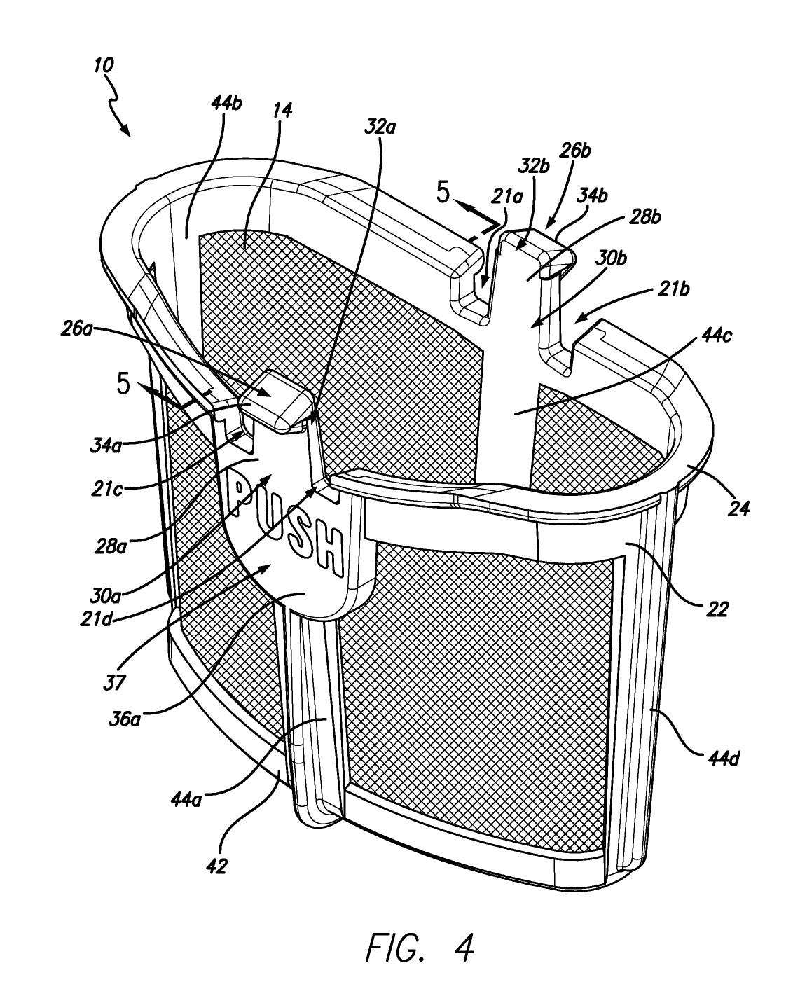

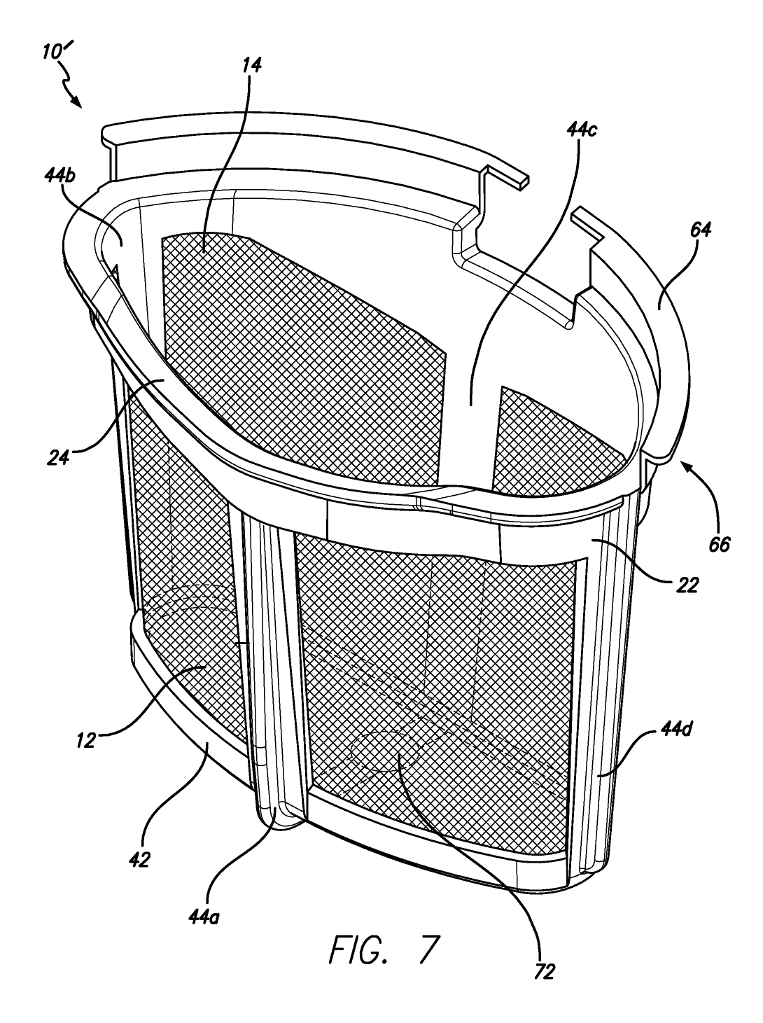

As shown in the drawings for the purposes of illustration, the present disclosure for a sediment filter is referred to generally by the reference numeral 10, 10′, or 10″ in FIGS. 1-9. In one embodiment, the sediment filter 10 as disclosed herein is preferably in the form of a generally three-sided upwardly open cup or basket having a porous base 12 and an at least partially porous sidewall 14 configured for selective engagement and placement within a carafe 16 to filter sediment (e.g., coffee grounds) or other particulate from a brewed beverage stream made by a brewer or the like. Brewed beverage enters the carafe 16 through an inlet port 18 formed in a carafe lid 20 generally covering the open upper rim of the carafe 16. The porous base 12 and the porous sidewall 14 permit the brewed beverage to flow therethrough while simultaneously filtering any sediment that may exit the brew basket (e.g., in the brewed coffee stream) before travel to the carafe 16. In this respect, as the brewed beverage flows through the porous base 12 and/or the porous sidewall 14, sediment carried within the brewed beverage is trapped by a mesh screen or comparable filter element generally forming the porous structure of the base 12 and/or the sidewall 14 to effectively filter out and remove sediment or suspended particulate that may pass to the carafe 16 from the brewer (e.g., the brew basket). The sediment filter 10 may further include at least one overflow channel 21a-d (shown best in FIG. 4) to permit selected and controlled overflow of brewed beverage that may remain inside the sediment filter 10 after the brew process is complete, due to an accumulation of sediment along the porous base 12 and/or the porous sidewall 14.

As illustrated in FIG. 4, the sediment filter 10 includes a solid, non-porous upper rim 22 that provides the main general support structure for the sediment filter 10. In this embodiment, the upper rim 22 is generally a spherical or oval shape, but a person of ordinary skill in the art will readily recognize that the upper rim 22 could be virtually any shape known in the art. In one embodiment, the upper rim 22 may create a seal between the carafe lid 20 and the sediment filter 10 to prevent unfiltered beverage spilling out the top of the carafe 16. The upper rim 22 may also optionally include a sealing lip 24 on a top surface thereof for pressure-sealed engagement with the carafe lid 20 to further improve sealing thereof. The sealing lip 24 is relatively wider than the rest of the upper rim 22, thereby increasing the mating surface area between the carafe lid 20 and the upper rim 22.

The upper rim 22 may include a pair of hooks 26a, 26b that selectively engage respective receptacles or apertures 27a, 27b in the carafe lid 22. In the embodiment shown in FIG. 4, e.g., the hooks 26a, 26b include an upwardly extending neck or vertical tab 28a, 28b having a proximal end 30 integrally formed from or coupled to the upper rim 22 and a distal end 32 having an outwardly-flared ledge or lobe 34a, 34b integrally formed with the respective tabs 28a, 28b. The outwardly-flared lobes 34a, 34b preferably extend outwardly perpendicular to the length of the respective elongated tab 28a, 28b. These elongated tabs 28a, 28b preferably elastically bend inwardly and outwardly to permit the outwardly flared lobes 34a, 34b to selectively engage or disengage the carafe lid 20 via the apertures or receptacles 27a, 27b.

The upper rim 22 also preferably includes a pair of enlarged areas or pinching surfaces 36a-b integrally formed therefrom or attached thereto, and positioned opposite one another as generally shown in FIG. 4. The pinching surfaces 36a-b provide enhanced surface area contact to facilitate selected inward displacement of the upper rim 22 and the elongated tabs 28a, 28b for releasing or engaging the hooks 26a, 26b with the carafe lid 20. More specifically, application of an inward force, e.g., along an arrow 37 shown in FIG. 4 (the opposite force/arrow not shown in FIG. 4), causes inward deflection of the upper rim 22 by way of a “pinching” action. Thus, the upper rim 22 preferably elastically deforms inwardly in the region proximate to each pinching surface 36a, 36b, resulting in similar inward displacement of the hooks 26a, 26b. In this inwardly deflected state, the hooks 26a, 26b move to a disengaged position relative to the respective receptacle or aperture 27a, 27b in the carafe lid 20. In this position, the sediment filter 10 may slide into the respective receptacle or aperture 27a, 27b for engagement therewith. When the force along the arrow 37 is released, the sediment filter 10 may slide out from the respective receptacle or aperture 27a, 27b to disengage the sediment filter 10 from the lid 20. It may be preferred to position the pair of pinching surfaces 36a, 36b proximate the hooks 26a-b to maximize displacement thereof. The pinching surfaces 36a, 36b may optionally be knurled or include a series of ribs or outward projections (e.g., the phrase “PUSH”) to facilitate fingertip engagement therewith.

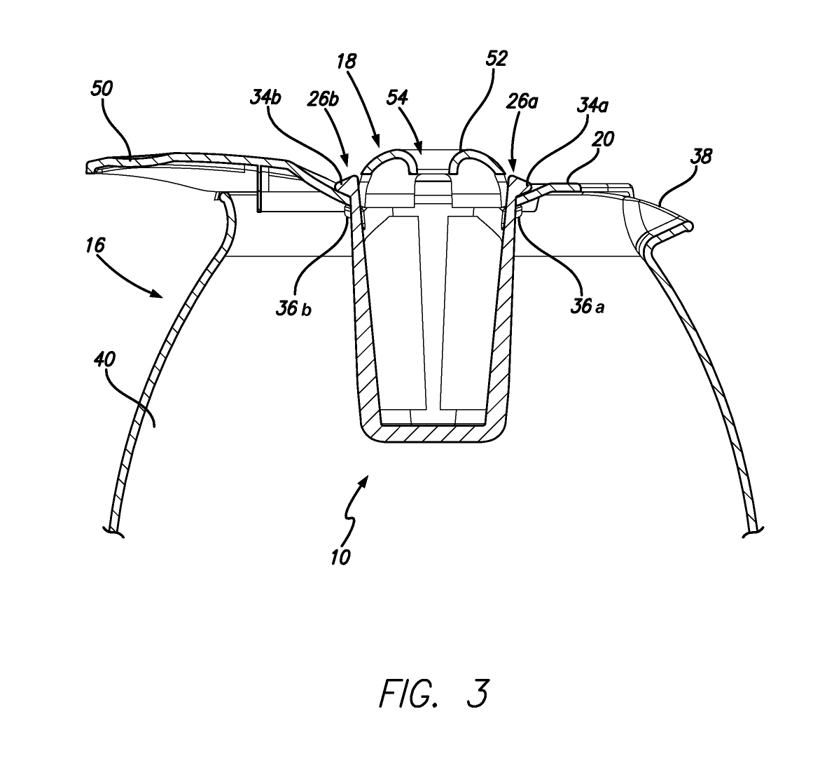

FIG. 4 also illustrates the overflow channels 21, such as the overflow channels 21a and 21b that flank the hook 26a, and the overflow channels 21c and 21d that flank the hook 26b. The overflow channels 21a-21d are generally formed as a cut-over or notch in or above the pinching surfaces 36a, 36b as shown in FIG. 3. In this respect, these cut-outs or notches adjacent the hooks 26a, 26b beneficially lengthen the elongated tabs 28a, 28b, thereby increasing the moment arm (and mechanical advantage) of the cantilever beam for selected elastic displacement of the hooks 26a, 26b, as described above. The overflow channels 21a-21d illustrated in FIG. 4 have a generally upwardly open rectangular cross section, but a person of ordinary skill in the art will recognize that the overflow channels 21a-21d may be any polygonal shape (e.g., triangular, pentagonal, hexagonal, etc.) or nonpolygonal shape (e.g., hemispherical), and may have an open top or a closed top (e.g., no break in the upper rim 22). While the embodiment in FIG. 4 illustrates four overflow channels 21a, 21b, 21c, 21d, the sediment filter 10 may include fewer than four overflow channels (e.g., one overflow channel) or more than four overflow channels, as may be desired. Preferably, the sediment filter 10 includes at least one of the overflow channels positioned toward the front of the sediment filter 10 (e.g., the overflow channel 21a or 21b) between the beverage inlet port 18 and a pour spout 38. In this respect, the overflow channel 21a or 21b is preferably below the beverage inlet port 18 during pouring to prevent any remaining liquid in the sediment filter 10 from spilling. That is, the remaining liquid in the sediment filter 10 will spill out through the overflow channel and into the carafe pot 40 before spilling out through the top or upper open rim of the carafe 16 when pouring brewed beverage out from within.

More specifically, to pour brewed beverage from the carafe 16, the carafe 16 retaining the brewed beverage in a beverage reservoir 40 is picked up by a handle 39, pulled out from underneath the brewer head and positioned at an angle that causes the brewed beverage therein to tip forward and flow out from the pour spout 38. In this pour position, the pour spout 38 is positioned below the upper level of brewed beverage in the reservoir 40, thereby causing the beverage to flow out therefrom. Depending on the size of the sediment filter 10, moving the pour spout 38 to this pour position may cause a similar forward tipping of any remaining liquid in the sediment filter 10 that may approach the height of the upper rim 22 and the inlet port 18. Thus, instead of this residual or remaining liquid potentially exiting the carafe 16 back through the inlet port 18 while pouring brewed beverage out therefrom, any leftover or residual liquid in the sediment filter 10 exits the lower threshold formed by the overflow channels 21a or 21b. That is, once leftover or residual liquid in the sediment filter 10 reaches the lower threshold of one or both of the open overflow channels 21a or 21b, the leftover or residual liquid flows through these channels 21a or 21b into the beverage reservoir 40 instead of out from the inlet port 18 or the open upper rim of the carafe 16. Of course, beverage stops flowing out from overflow channel 21a or 21b once the leftover liquid in the sediment filter 10 drops below the threshold level, which typically includes only a small amount of liquid, if any at all.

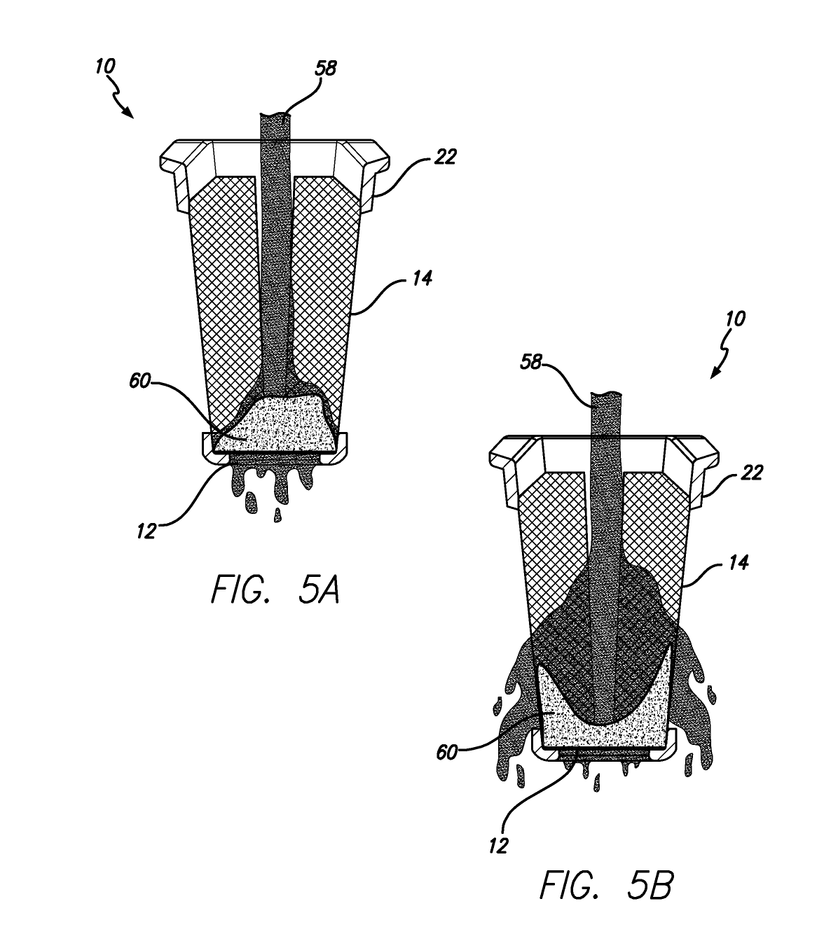

Any of the overflow channels 21a-21d may also act to prevent overflow from the carafe lid 20 during a brew cycle. The overflow channels 21a-21d allow brewed beverage to exit the sediment filter 10 during a brew cycle in the event the sediment filter 10 cannot filter brewed beverage out therefrom at a rate faster than the rate the freshly brewed beverage enters the carafe 16 via the inlet port 18. This situation may occur if the porous base 12 and/or the porous sidewalls 14 become substantially blocked by sediment filtered from the brewed beverage by the filter 10. Typically, as shown in FIGS. 5A and 5B, sediment will only block a portion of the porous base 12 and/or a portion of the porous sidewalls 14, thereby slowing the rate filtered beverage exits the sediment filter 10. But, as the sediment builds, brewed beverage filters out from the larger surface area porous sidewalls 14. If the porous sidewalls 14 become substantially blocked, the filtration rate may slow down to a point where the overflow channels 21a-21d may be useful in preventing overflow out through the lid 20, as mentioned above.

As shown best in FIG. 4, the porous base 12 and the porous sidewalls 14 may form a basket-shaped filter 10 by way of a lower elastic and non-porous bottom support member 42 having a similar circular or oval structure forming a supportive bottom periphery of the filter 10, with one or more elastic, non-porous vertical or side support members 44 (e.g., side support members 44a-44d shown in FIG. 4) coupling or connecting the lower or bottom support member 42 to the upper rim 22. The bottom support member 42 and/or the side support members 44 provide additional support for and increase the overall strength and rigidity of the frame of the sediment filter 10. Similar to the upper rim 22, the bottom support member 42 and the side support members 44a-d may be made from a substantially plastic material that permits relative elastic movement for connecting the filter 10 to the carafe lid 20, as described above. In the embodiment disclosed herein, the vertical support members 44a-44d are disposed intermittently around the periphery of the filter 10, thereby effectively forming four porous sidewall sections 14. Of course, the sediment filter 10 may include various combinations of the bottom support member 42 and the side support members 44. For example, the sediment filter 10 may include two, three, or more support members 44 in combination with the bottom support member 42. Alternatively, and less preferably, the filter 10 may include one or more side support members 44 and no bottom support member 42, or no side support members 44 and the bottom support member 42. In the latter embodiment, the upper rim 22 and the bottom support member 42 may be coupled or connected to one another only by the mesh or porous sidewall 14.

Brewed beverage entering the reservoir 40 is filtered first by the porous base 12 as a result of being positioned directly below the incoming stream of brewed beverage through the inlet port 18, and then by the porous sidewalls 14, as needed. The porous base 12 and the porous sidewalls 14 are preferably constructed from an interwoven metallic mesh material suitable for filtering hot or cold beverages, such as coffee and tea. Although, the porous base 12 and/or the porous sidewalls 14 may be constructed from a non-metallic mesh or other porous filtration material suitable to filter sediment out from brewed beverage dispensed from a brewer. That is, the porous base 12 and the porous sidewalls 14 permit brewed beverage or liquid to flow therethrough, while simultaneously trapping larger particles or sediment that may be carried by the brewed beverage or liquid out from the brewer head. The porous base 12 may be made from a finer mesh material since brewed beverage or liquid entering the filter 10 contacts the base 12 at a higher velocity and with greater force and may, as a result, have a tendency to push unwanted particles or sediment through the mesh surface.

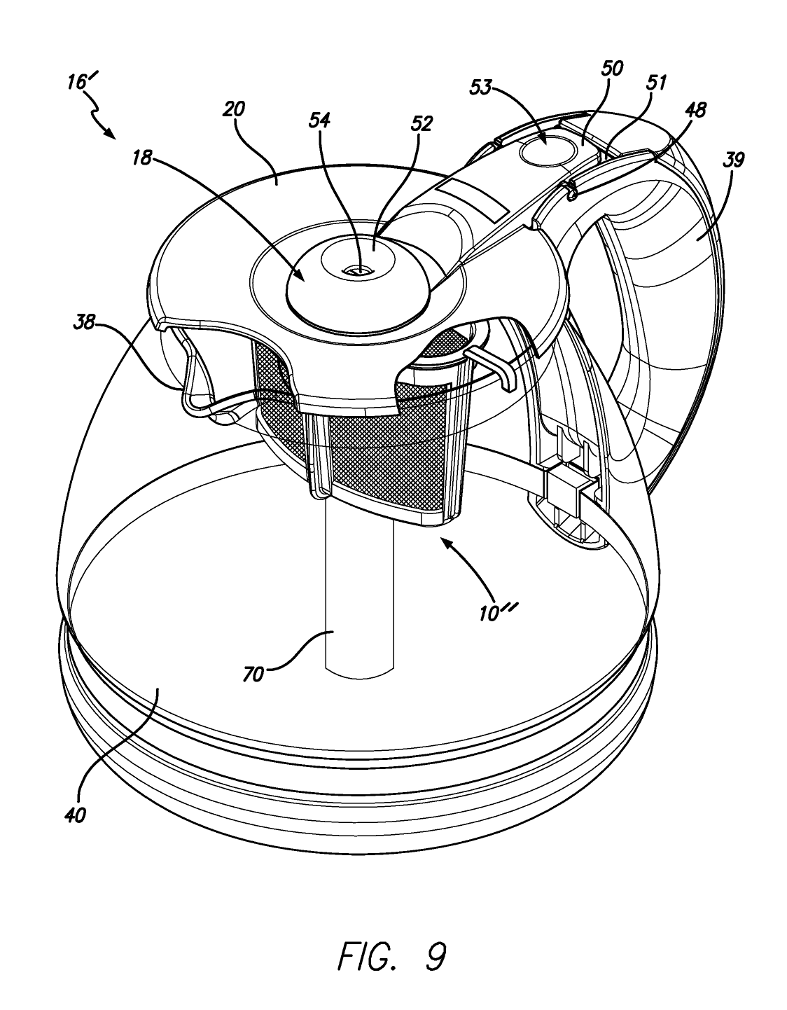

The lid 20 of the carafe 16 is coupled to the handle 39 about a pivot 48, as shown in FIGS. 1-2, 6 and 8-9. The carafe lid 20 further preferably includes an integral actuating tab 50 extending outwardly therefrom and generally positioned above a cavity 51 formed from a portion of the handle 39. The gap or space formed by the cavity 51 permits clockwise movement of the actuating tab 50 about the pivot 48. In this respect, applying a downward force, e.g., along arrow 53 (FIGS. 1 and 9), displaces the actuating tab 50 down into the cavity 51, thereby causing rotation about the pivot 48, effectively angularly or curvilinearly lifting the lid 20 off the carafe 16. In this embodiment, the sediment filter 10 lifts and rotates with the lid 16. As a result, the filter 10 tips from being substantially horizontal to an angled position, depending on the distance the lid 16 pivots. Thus, it may be desirable to include at least one of the overflow channels 21c or 21d on a side proximate the handle 39 to prevent spillage of any leftover liquid remaining in the filter 10 when the filter 10 lifts and rotates with the lid 10, as described above.

As mentioned above, the beverage inlet port 18 permits brewed beverage to enter the carafe 16 when the carafe lid 20 is closed (i.e., covering the opening of the carafe 16). As illustrated in FIGS. 1-3, 6 and 9, in the preferred embodiment, the inlet port 18 has a dome-shape structure with a concave depression 52 formed therein for receiving brewed beverage exiting a brewer head (not shown), such as a coffee brewer. The concave depression 52 funnels the brewed beverage into a fill port passageway 54, which conducts the brewed beverage into the reservoir 40. The concave depression 52 is preferably substantially wider at its top and funnels downwardly into the passageway 54 to better ensure that the brewed beverage dispensed from the brewer head is channeled through the inlet port 18, even if ambient air flow conditions (e.g., air flow from an air conditioning vent) cause slight variations in the trajectory of the brewed beverage dispensing from the brewer head. The inlet port 18 may, alternatively, have any shape or structure known in the art suitable for receiving and channeling brewed beverage into the carafe 16.

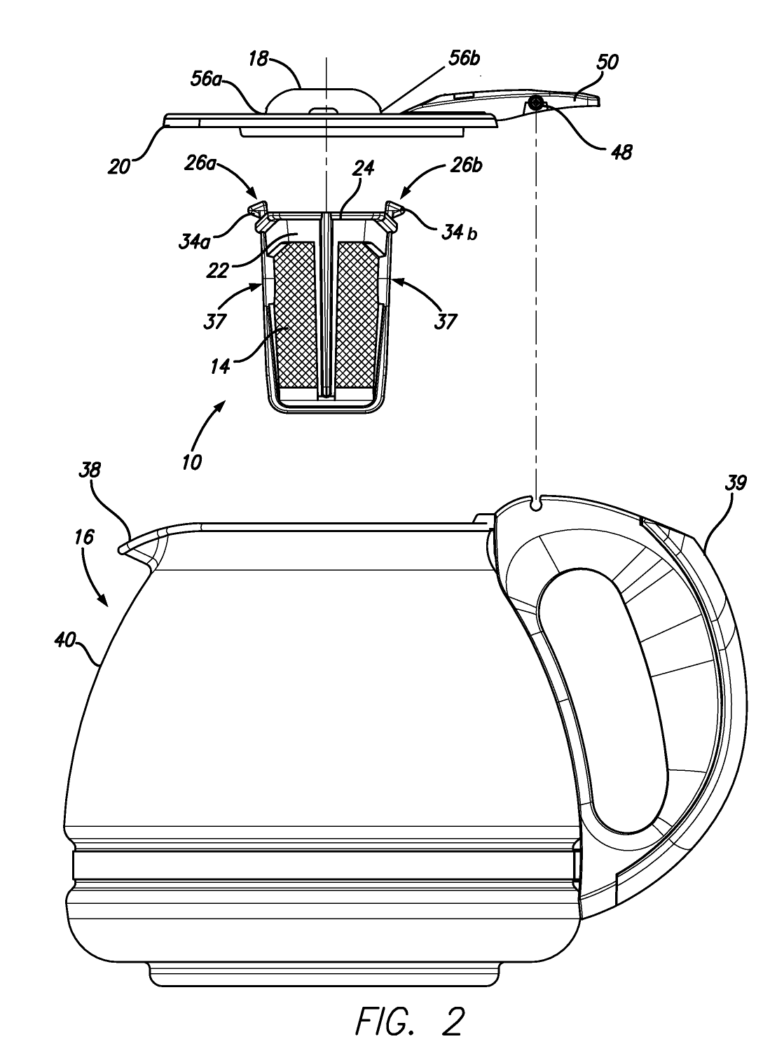

As briefly described above, the sediment filter 10 may selectively attach to the carafe lid 20 via hook-in engagement with the pair of hooks 26a, 26b. In this embodiment, as shown in FIGS. 1-3, the carafe lid 20 preferably includes a pair of respective hook-retention receptacles 56a, 56b, which selectively receive and retain the respective hooks 26a, 26b from the sediment filter 10. The sediment filter 10 attaches to the carafe lid 20 by inserting the hooks 26a, 26b into the receptacles 56a, 56b from the bottom of the carafe lid 20. As best shown in FIG. 2, the outwardly-flared lobes 34a, 34b are in a position to extend out over a top surface of the lid 20 when the filter 10 is in an uncompressed or static state. Thus, it is necessary to apply a force about the arrows 37 at the pinching surfaces 36a, 36b to compress the lobes 34a, 34b inwardly to permit insertion into the receptacles 56a, 56b. Elastically deflecting the tabs 28a, 28b and the respective outwardly-flared lobs 34a, 34b inwardly decreases the distance therebetween to permit insertion alignment with the hook-retention receptacles 56a, 56b. In this respect, with the hooks 26a, 26b slightly compressed inwardly, the sediment filter 10 is moved upwardly and inwardly into the hook-retention receptacles 56a, 56b for engagement therewith. Once the hooks 26a, 26b emerge out through the hook-retention receptacles 56a, 56b, the pressure along the arrows 37 is released and the hooks 26a, 26b again elastically expand outwardly to an uncompressed or static non-deflected state. Here, the lobes 34a, 34b extend out over a portion of the surface of the lid 20 in hooked engagement therewith.

With the sediment filter 10 installed underneath the carafe lid 20, the carafe 16 is placed under a beverage source (not shown) such as a coffee brewer or tea steeper to filter sediment or other particulate that may be suspended in the brewed beverage. The beverage source supplies a quantity of brewed beverage to the carafe 16 and the sediment filter 10 through the beverage inlet port 18 in the carafe lid 20. The brewed beverage enters the beverage inlet port 18 and through the passageway 54 en route to the filter 10 for filtration. In this respect, FIGS. 5A and 5B illustrate a stream of brewed beverage 58 entering the filter 10. Here, the beverage stream 58 initially falls to the bottom of the filter 10 and onto the porous base 12. At least initially, the majority of the brewed beverage is filtered by the porous base 12 as shown in FIG. 5A. The brewed beverage passes through the porous base 12 and into the reservoir 40 below. As the brewing cycle continues, the porous base 12 may start to collect a layer of accumulated sediment 60 on the porous base 12, thereby decreasing the rate the porous base 12 filters brewed beverage to the reservoir 40. In this respect, as the mesh surface of the porous base 12 becomes blocked with the sediment accumulation 60, additional filtration occurs through the porous sidewalls 14, as best shown in FIG. 5B. Here, the sidewalls 14 increase the rate of brewed beverage filtration despite a decreased filtration rate through the porous base 12 due to sediment accumulation 60 thereon. Thus, the porous bottom 12 and the porous sidewalls 14 act in concert to remove and trap sediment within the interior of the sediment filter 10, thereby preventing the sediment from passing to the beverage reservoir 40 below. Importantly, the sediment accumulation 60 does not prevent continued brewed beverage filtration through the porous base 12 and the porous sidewalls 14 during the brew cycle. While the sediment accumulation 60 may reduce the flow rate of the brewed beverage through certain areas of the filter 10, the relatively large surface area of the porous sidewalls 14 ensures continued filtration.

In one embodiment, the porous base 12 is a finer filter (i.e., smaller passageways) than the porous sidewall 14 to prevent sediment from being forced through the mesh surface as a result of pressurized landing of the brewed beverage stream 58 thereon. Gravity causes the brewed beverage stream 58 to exert a greater pressure and force on the sediment accumulation 60 on the porous base 12 than on the porous sidewall 14, so the finer filter material has the ability to better withstand unwanted passage of particulate matter to the reservoir 40. As the sediment accumulation 60 layers on the porous base 12, the brewed beverage in the sediment filter 10 begins to filter out through both the porous base 12 and the porous sidewalls 14. While the force of the brewed beverage steam 58 landing on the porous base 12 causes a greater exertion of pressure thereon, the finer mesh filter ensures that little or no unwanted particulate passes to the reservoir 40. Thus, the relatively finer porous base 12 effectively traps sediment accumulation 60 under higher pressures, while the courser mesh of the porous sidewalls 14 facilitates a greater overall rate of beverage filtration without the passage of particulate.

After a brew cycle, the sediment filter 10 may be selectively disengaged from the lid 20 to clean the sediment accumulation 60 therein. To remove the sediment filter 10 from the lid 16, one must first open the carafe lid 20 to gain access to the sediment filter 10, and specifically the pinching surfaces 36a, 36b. As described above, one may open the carafe lid 20 by pressing down on the actuating tab 50 along the directional arrow 53 (FIGS. 1 and 9). Doing this causes the carafe lid 20 and attached filter 10 to rotate clockwise about the pivot 48 in an angular or curvilinear fashion. Thus, the depth of the sediment filter 10 must be shallow enough to prevent the sediment filter 10 from interfering with opening the carafe lid 20 (i.e., preventing the carafe lid 20 from lifting off the carafe 16). After opening the carafe lid 20, to remove the sediment filter 10 from the lid 20, one must apply an inward pressure to the pinching surfaces 36a, 36b along the arrows shown in FIG. 2 to retract the hooks 26a, 26b and the respective lobes 34a, 34b out from engagement with the top of the lid 20. Once aligned with the receptacles 56a, 56b, the filter 10 may be pulled downwardly and out of engagement with the lid 10.

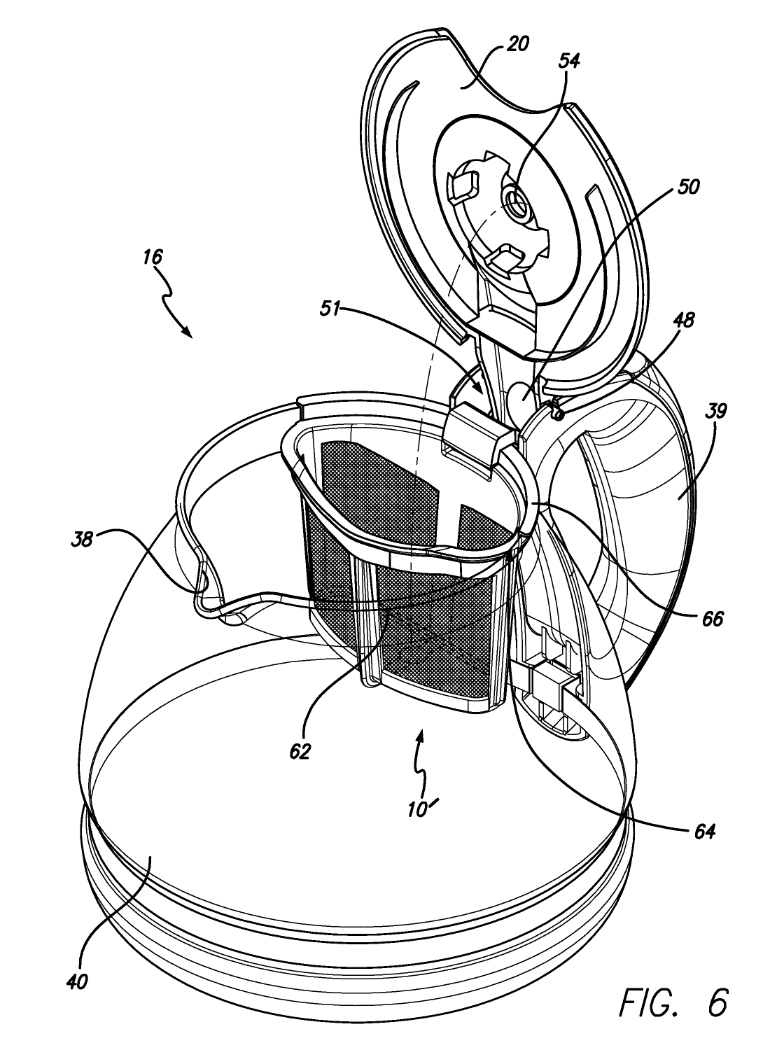

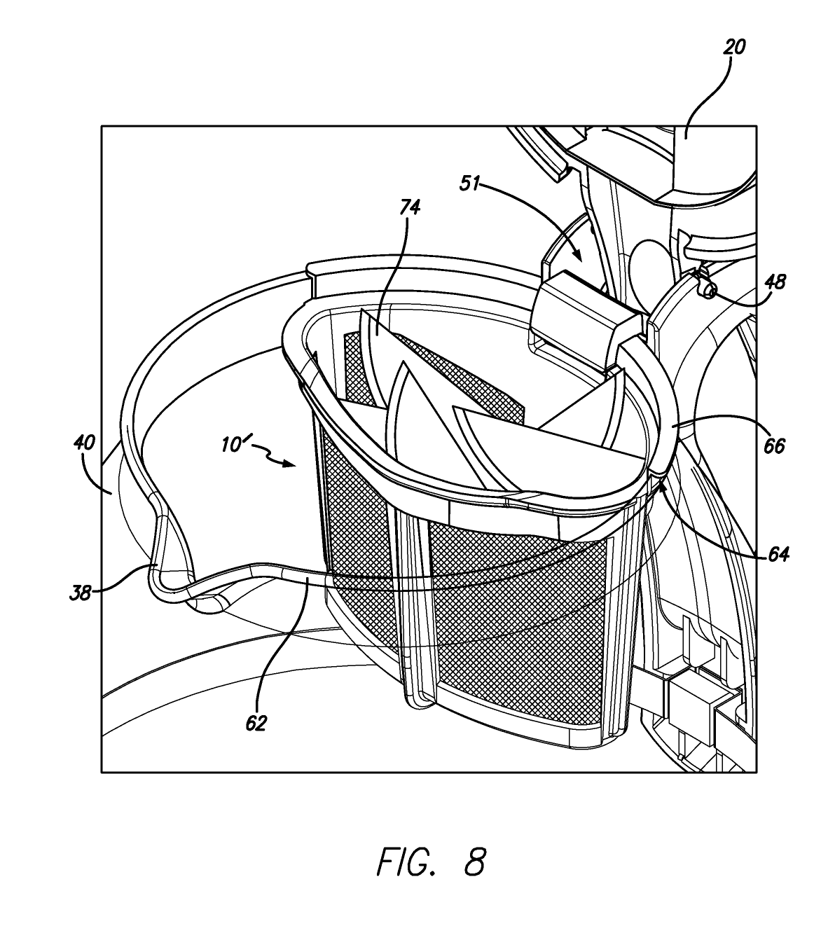

Importantly, the sediment filter 10 may be attached to the carafe 16 by any suitable method, not just hook-fit reception, as described above. For example, a sediment filter 10′ may attach to a rim 62 of the carafe 16, instead of to the carafe lid 20. As illustrated in FIGS. 6 and 8, the filter 10′ may include a plurality of support arms 64 fixedly attached to the sediment filter 10′ and extending outwardly therefrom to support the sediment filter 10′ in a suspended orientation over the carafe 16 within the reservoir 40. The support arms 64 may include an engagement channel 66 that tracks a portion of the curved rim 62 for snap-fit engagement therewith, as shown best in FIGS. 6 and 8. The engagement channel 66 prevents lateral movement of the sediment filter 10 and snaps tight on to the outside of the rim 62 to prevent the engagement channels 66 from sliding off the carafe 16. In this embodiment, the filter 10′ may simply snap into the open rim 62 when the lid 20 is open, and may likewise be unsnapped therefrom after a brew cycle. The alternative filter 10′ also includes a circular landing 72 preferably positioned underneath or aligned with the incoming brewed beverage stream 58. The landing 72 is preferably made from the same or similar material as the upper rim 22, the bottom support member 42 or the side support members 44, i.e., a hard or semi-elastic plastic material or the like. The landing 72 is designed to prevent the stream 58 from immediately contacting the mesh portion of the porous base 12 during a brew cycle.

In another embodiment shown in FIG. 9, an alternative sediment filter 10″ may be suspended under the beverage inlet port 18 by a support post 70 extending upwardly from a bottom interior surface of an alternative carafe 16′. In this embodiment, the alternative sediment filter 10″ is preferably selectively removable from the post 70 (e.g., by being unscrewed or unsnapped therefrom). That is, the sediment filter 10″ may be removable from the support post 70, while the support post 70 is fixedly attached to the carafe 16′. Alternatively, the support post 70 and the sediment filter 10″ may be fixed together and removable as one unit from the carafe 16′. In yet another alternative embodiment, the sediment filter 10″, the support post 70, and the carafe 16′ may all be removably attached to each other. Importantly, the construction and operation of sediment filters 10′, 10″ is substantially the same as the filter 10, described above, and the filtration techniques described herein are not otherwise affected by the method of attachment to the carafe 16. In this respect, FIGS. 6-9 illustrate other related views of a sediment filter 10 falling within the scope of the present disclosure. Additionally, FIG. 8 illustrates the sediment filter retaining lemon slices 74 for imparting lemon flavor to a brewed beverage passing therethrough to the reservoir 40.

Although several embodiments have been described in detail for purposes of illustration, various modifications may be made without departing from the scope and spirit of the invention. Accordingly, the invention is not to be limited, except as by the appended claims.

What is claimed is:

1. In a carafe for placement in a brewer to receive brewed beverage passing therefrom, a sediment filter, comprising:
a mesh wall forming a portion of the exterior of the sediment filter to trap particulate within a brewed beverage stream passing from the brewer head into the carafe; and
means for mounting the sediment filter into the carafe in a position to interrupt and to receive the brewed beverage stream.

2. The sediment filter of claim 1 wherein said mesh wall forms a portion of the bottom of said sediment filter.

3. The sediment filter of claim 1 wherein said mesh wall forms a portion of a sidewall of said sediment filter.

4. The sediment filter of claim 1 wherein said mesh wall forms at least a portion of a bottom wall and a sidewall of said sediment filter.

5. The sediment filter of claim 1 wherein the sediment filter includes a upper rim having a seal lip formed thereon for sealably engaging a lid of said carafe, said lid defining a flow port for the brewed beverage stream to enter said carafe.

6. The sediment filter of claim 5 wherein said upper rim has at least one upper flow port formed therein.

7. The sediment filter of claim 5 wherein said upper rim has a plurality of upper flow ports formed therein.

8. The sediment filter of claim 6 wherein said at least one upper flow port is formed in said sediment filter at a front wall thereof.

9. The sediment filter of claim 8 wherein said mounting means comprises a pair of hooks formed generally at opposite sides of said upper rim, said hooks being formed at a front wall and at a rear wall of said sediment filter, said at least one upper flow port comprising a pair of upper flow ports formed on opposite sides of a front one of said hooks.

10. The sediment filter of claim 9 wherein said front wall and said rear wall of said sediment filter include deformation indicia.

11. The sediment filter of claim 1 wherein said sediment filter includes a plurality of outwardly extending support arms for supporting said sediment filter from an upper rim of said carafe.

12. The sediment filter of claim 11 including a support post extending from a bottom wall of said sediment filter to engage a bottom of said carafe.

13. The sediment filter of claim 9 wherein said lid of said carafe includes a pair of receptacles shaped for engagement with said pair of hooks, respectively, to mount said sediment filter onto said carafe lid.

14. The sediment filter of claim 1 wherein said sediment filter includes a lid having an outwardly projecting tab, and a pivot attachment of said lid to said carafe whereby pivot movement about said pivot attachment upon depression of said tab opens and closes said lid,

15. In a carafe for placement in a brewer to receive brewed beverage passing therefrom, a sediment filter, comprising:
a mesh wall forming a portion of the exterior of the sediment filter to trap particulate within a brewed beverage stream passing from the brewer head into the carafe, said mesh wall forming at least a portion of a bottom wall and a sidewall of said sediment filter.; and
means for mounting the sediment filter into the carafe in a position to interrupt and to receive the brewed beverage stream.

16. The sediment filter of claim 15 wherein the sediment filter includes a upper rim having a seal lip formed thereon for sealably engaging a lid of said carafe, said lid defining a flow port for the brewed beverage stream to enter said carafe.

17. The sediment filter of claim 16 wherein said upper rim has a plurality of upper flow ports formed therein.

18. The sediment filter of claim 17 wherein said mounting means comprises a pair of hooks formed generally at opposite sides of said upper rim, said hooks being formed at a front wall and at a rear wall of said sediment filter, said pair of upper flow ports being formed on opposite sides of a front one of said hooks.

19. The sediment filter of claim 19 wherein said front wall and said rear wall of said sediment filter include deformation indicia.

20. The sediment filter of claim 1 wherein said sediment filter includes a plurality of outwardly extending support arms for supporting said sediment filter from an upper rim of said carafe.

21. A process of filtering sediment from a sediment stream of a brewed beverage passing from a brew head downwardly into an underlying carafe, said process comprising the steps of:
forming sediment filter having a mesh wall defining at least apportion of a bottom wall or at least a portion of a sidewall thereof; and
mounting the sediment filter into the carafe in a position to interrupt and to receive the brewed beverage stream to trap particulate therein.

22. The process of claim 21 wherein said mounting step comprises mounting said sediment filter within said carafe in a position suspended from a lid of said carafe, said lid having a flow port formed therethrough to permit downward passage of the brewed beverage stream into said carafe into said sediment filter.

23. The process of claim 21 including the step of forming a plurality of upper flow ports in an upper rim of said sediment filter.

24. The process of claim 23 wherein said plurality of upper flow port is formed in said sediment filter at a front wall thereof.

25. The process of claim 24 wherein said mounting step comprises forming mounting means comprising a pair of hooks formed generally at opposite sides of said upper rim, said hooks being formed at a front wall and at a rear wall of said sediment filter, said plurality of flow ports comprising a pair of flow ports formed on opposite sides of a front one of said hooks.

26. The process of claim 25 including the step of forming said front wall and said rear wall of said sediment filter to include deformation indicia.
